(19) United States
(12) Patent Application Publication
(10) Pub. No.: US 2026/0195076 A1
(43) Pub. Date: Jul. 9, 2026

(54) NON-TRANSITORY COMPUTER READABLE STORAGE MEDIUM

(71) Applicant: BROTHER KOGYO KABUSHIKI KAISHA, Nagoya (JP)

(72) Inventors: Kenju NARITA, Nagoya (JP); Airi EGUCHI, Ichinomiya (JP); Yoshito HOSOMIZO, Konan (JP)

(21) Appl. No.: 19/557,694

(22) Filed: Mar. 5, 2026

Related U.S. Application Data
(63) Continuation of application No. PCT/JP2024/045151, filed on Dec. 20, 2024.

(30) Foreign Application Priority Data
Jan. 25, 2024 (JP) 2024-009373

(51) Int. Cl. G06F 3/12

(52) U.S. Cl. CPC G06F 3/1205; G06F 3/1232; G06F 3/1234

(57) ABSTRACT

A non-transitory computer readable storage medium storing a support program. At least one of a general-purpose printing program and the support program causes a computer to communicate with a printer to acquire capability information, and store the acquired capability information in a memory of an information processing device, The general-purpose printing program and the support program are configured to cause the computer to receive a print setting for causing the printer to execute printing based on the capability information. The support program includes acquiring specific information indicating that a capability of the printer is changed. The support program includes, in response to acquisition of the specific information, acquiring the capability information from the printer and updating the capability information stored in the memory.

### REFERENCE TO RELATED APPLICATIONS

This is a continuation application of International Application No. PCT/JP2024/045151 filed on December 20, 2024, which claims priority from Japanese Patent Application No. 2024-009373 filed on January 25, 2024. The entire contents of the aforementioned applications are incorporated herein by reference.

### BACKGROUND ART

In recent years, a technique has been put into practical use in which a printer is controlled by an OS-standard general-purpose printing program that is part of the operating system (OS), without using a printer driver provided by a printer vendor. With this technique, when the OS detects a printer, association with the OS-standard general-purpose printing program is performed, and thereafter, when a print instruction for the printer is received, the OS-standard general-purpose printing program generates print data without using the printer driver provided by the printer vendor, making it possible to print using the OS-standard general-purpose printing program.

For example, a related art discloses a technique related to an OS-standard general-purpose printing program. The related art discloses a support program that supports a general-purpose printing program, which, if capability dependent information based on capability information of a printer is cached at a timing when the printer is selected, reads the cached capability dependent information, and if the capability dependent information is not cached, acquires the capability information from the printer and caches the capability dependent information based on the acquired capability information.

The capability of the printer changes depending on the status of the printer, such as attachment and detachment of additional trays. For this reason, if the capability information of the printer is acquired when the printer is selected, data based on the capability information is cached, and then the cached capability information is used as in the configuration of the related art, a current capability of the printer may not be accommodated.

### SUMMARY

A non-transitory computer readable storage medium storing a support program for solving the above-described problems, the support program is executable by a computer of an information processing device, corresponds to a printer connected to the information processing device, and supports a general-purpose printing program incorporated in an operating system of the information processing device. At least one of the general-purpose printing program and the support program causes the computer to communicate with the printer to acquire capability information indicating a capability of the printer, and store the acquired capability information in a memory of the information processing device. The general-purpose printing program and the support program are configured to cause the computer to receive a print setting for causing the printer to execute printing based on the capability information stored in the memory. The support program causes the computer to execute an acquisition process of acquiring specific information indicating that a capability of the printer is changed. The support program further causes the computer to execute, in response to acquisition of the specific information in the acquisition process, an update process of acquiring the capability information from the printer and updating the capability information stored in the memory.

### BRIEF DESCRIPTION OF THE DRAWINGS

FIG. 1 is a block diagram showing an outline of an electrical configuration of a PC.

FIG. 2 is a sequence diagram showing an example of a print setting procedure.

FIG. 3 is a sequence diagram showing an example of a printing execution procedure.

FIG. 4 is a sequence diagram showing an example of a procedure to be performed after an error occurs.

FIG. 5 is a block diagram showing an outline of an electrical configuration of a PC.

FIG. 6 is a sequence diagram showing an example of a printing execution procedure.

### DESCRIPTION

Hereinafter, a personal computer (hereinafter, referred to as a "PC") that uses a support program according to a first aspect will be described in detail with reference to the accompanying drawings. The present specification discloses a support program that runs on the PC.

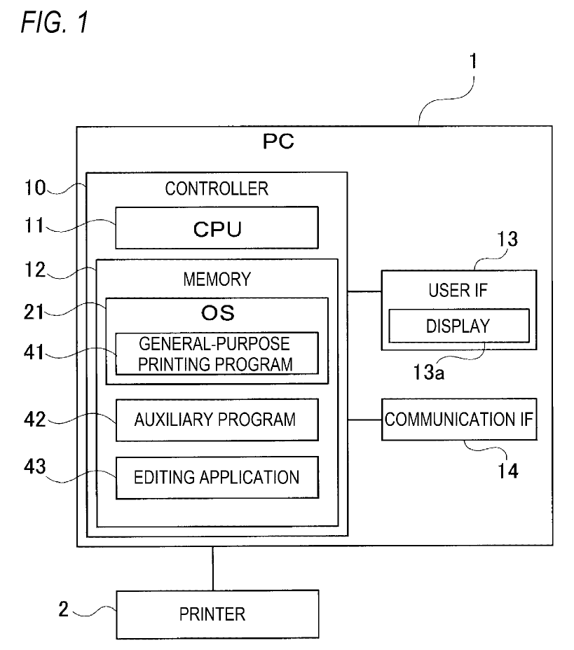

As illustrated in FIG. 1, a PC 1 according to the present aspect includes a controller 10 including a CPU 11 and a memory 12. The PC 1 is an example of the information processing device. The CPU 11 is an example of the computer. The PC 1 includes a user interface (hereinafter, referred to as a "user IF") 13, and a communication interface (hereinafter, referred to as a "communication IF") 14 that are electrically connected to the controller 10. The controller 10 in FIG. 1 is a collective term for hardware and software used to control the PC 1, and does not necessarily represent a single piece of hardware actually present in the PC 1.

The CPU 11 of the PC 1 is configured to execute various types of processes, in accordance with a program read from the memory 12 and based on a user operation. The memory 12 stores various programs and various data. The memory 12 is used as a work area in a case where various types of processes are executed. A buffer provided in the CPU 11 is also an example of the memory. An example of the memory 12 is not limited to a ROM, a RAM, a HDD, and the like built into the PC 1, but may also be a storage medium that can be read and written by the CPU 11, for example, a recording medium such as a CD-ROM, and a DVD-ROM.

The user IF 13 includes a display 13a which is hardware that displays a screen for reporting information to a user, and hardware that receives an operation from the user. The user IF 13 may be a combination of the display 13a capable of displaying information and a mouse, a keyboard, or the like having an input receiving function, or may be a touch panel having the functions of the display 13a and the input receiving function.

The communication IF 14 includes hardware for communicating with an external device such as a printer 2. Communication standards of the communication IF 14 include Ethernet (registered trademark), Wi-Fi (registered trademark), USB, and the like. The PC 1 may be connectable to the Internet via the communication IF 14. The PC 1 may include a plurality of communication IFs 14 corresponding to a plurality of communication standards.

As shown in FIG. 1, the memory 12 of the PC 1 stores various programs and various data including an operating system (hereinafter, referred to as "OS") 21 including a general-purpose printing program 41, an auxiliary program 42, and an editing application 43. The auxiliary program 42 is an example of the support program.

The OS 21 is a multitasking OS that can process a plurality of tasks in parallel by managing and switching between the plurality of tasks. The OS 21 is, for example, Windows (registered trademark), macOS (registered trademark), Linux (registered trademark), iOS (registered trademark), or Android (registered trademark).

The OS 21 includes the general-purpose printing program 41. The general-purpose printing program 41 is an OS-standard program prepared by a vendor of the OS 21 and provided as a part of the OS 21. That is, the PC 1 is equipped with the OS 21 having the general-purpose printing program 41. The general-purpose printing program 41 is not configured to use a printer driver specific to each printer.

The general-purpose printing program 41 is a program having a function of causing printers of a plurality of types of models respectively provided by a plurality of vendors to execute printing based on an instruction of a user. The general-purpose printing program 41 supports a general-purpose function that enable printing to be performed on many printers. Unlike a printer driver specific to each printer, the general-purpose printing program 41 does not support functions specific to each printer or printer driver, in particular, functions that require complex processes.

The general-purpose printing program 41 is a program that includes a function of receiving image data designated as a printing target by a print instruction output from various applications based on an instruction of a user, and generating intermediate data based on the image data. The intermediate data is, for example, XPS data. The general-purpose printing program 41 further has a function of generating print data in a format that can be used for printing on various printers, based on the intermediate data. The print data is, for example, PWG Raster data or PDF data. The general-purpose printing program 41 has a function of transmitting the generated print data to a printer designated as a device to execute printing, via a communication function of the OS 21.

The auxiliary program 42 is a program or a group of programs that executes processes based on an instruction from the OS 21 in conjunction with the process of the general-purpose printing program 41, and is a program that supports the control of target hardware. The auxiliary program 42 of the present aspect corresponds to a model of the printer 2 connected to the PC 1, and is provided by, for example, the vendor of the printer 2. The general-purpose printing program 41 activates the auxiliary program 42 compatible with the printer 2 when the printer 2 is selected as a device for executing printing, when an instruction for detailed print settings is received in a state where the printer 2 is selected, when an instruction for causing the printer 2 to execute printing is received, or the like. The auxiliary program 42 is called, for example, a print support application (abbreviated as PSA) or a hardware support application (abbreviated as HSA).

The auxiliary program 42 may be a combination of a plurality of programs each of which receives an execution command, or may be one single program that can execute different processes in response to commands. Further, the auxiliary program may be a program prepared for each type of printer by the vendor of the printer. For example, an auxiliary program for an inkjet printer and an auxiliary program for a laser printer may be prepared separately. The auxiliary program may be prepared not only for each type of printer, but also for each model of printer or each series of printer models.

For example, when a new printer is connected to the PC 1, the OS 21 of the PC 1 can download an appropriate auxiliary program from a server or the like of the vendor of the printer or storage specified by OS 21 according to the type or model of the connected printer and incorporate the auxiliary program into the PC 1. The OS 21 stores identification information of the incorporated auxiliary program in the memory 12 in association with printer information of the newly connected printer.

The editing application 43 is, for example, a program for creating and editing image data and document data. The editing application 43 may be, for example, Microsoft Word (registered trademark) or PowerPoint (registered trademark) manufactured by Microsoft (registered trademark), or may be a program provided by the vendor of the printer 2. The editing application 43 can receive, via the user IF 13, a print execution instruction to cause the printer 2 to execute printing, for example. The editing application 43 is not limited to a program for creating or editing data, and may be a program that has a function of receiving a display instruction or a print instruction for various kinds of information such as map information or a web page in response to user requests.

The PC 1 of the present aspect is connected to the printer 2 via the communication IF 14 as shown in FIG. 1. The printer 2 is a device that has at least a printing function and a communication function. For example, when receiving print data from the PC 1 or the like, the printer 2 can execute printing based on the received print data. The printer 2 may be a device capable of color printing, or may be a device capable of only monochrome printing.

Next, the procedure of a process related to printing by the printer 2 in the PC 1 of the present aspect will be described. Each process other than the operation of a user in the present aspect basically indicates a process of the CPU 11 according to instructions written in a program such as the auxiliary program 42. In the present specification, various processes performed by the controller 10 or the CPU 11 according to programs such as the auxiliary program 42, the general-purpose printing program 41, and the OS 21 may be described as if each program were performing the various processes independently for convenience. The process executed by the CPU 11 also includes control of hardware using API of the OS 21. In the present specification, a detail description of the OS 21 is omitted, and an operation of each program is described. The term "acquisition" is used as a concept indicating that a request is not essential.

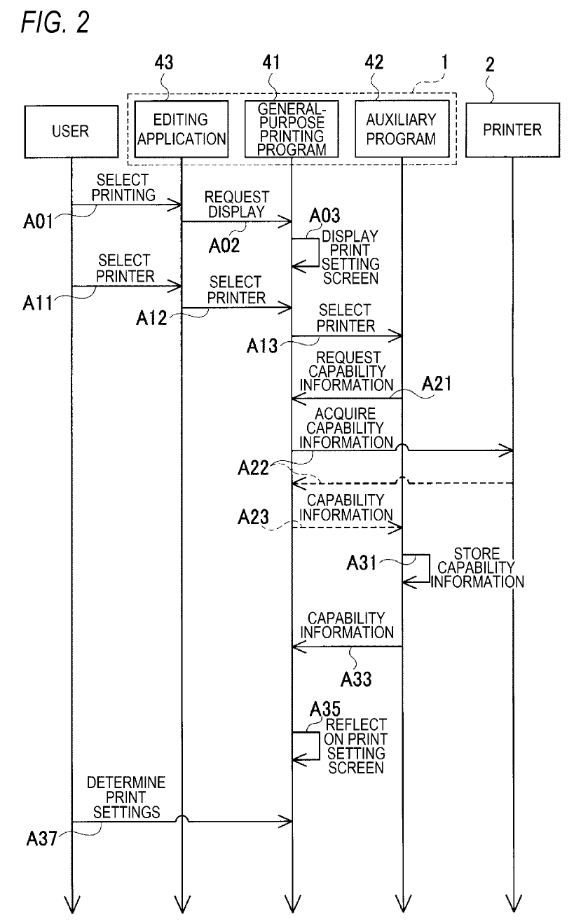

First, a print setting procedure for selecting a printer to be used for printing and receiving print settings will be described with reference to the sequence diagram of FIG. 2. The editing application 43 can create and edit text and images based on an instruction from the user. If the user intends to print a text or image being displayed, the user selects print in the editing application 43 (A01). The user can select print from a menu of operation items provided in the editing application 43, for example.

Upon receiving the selection of printing, the editing application 43 requests the general-purpose printing program 41 of the OS 21 to display a screen for receiving instructions regarding the printing (A02). In response to the request, the general-purpose printing program 41 displays a print setting screen on the user IF 13 (A03). The print setting screen is a screen that receives instructions from the user regarding various print settings that can be accepted by the general-purpose printing program 41. The print setting screen may be displayed by the editing application 43. The print setting screen may have a region where information specified by the auxiliary program can be displayed.

For example, in a case where a selection instruction to select the printer 2 as a device to execute printing is received on the print setting screen (A11), or in a case where selection of printing in A01 is received with the printer 2 selected as the device to execute printing, the editing application 43 passes information indicating that the printer 2 is selected to the general-purpose printing program 41 (A12). The general-purpose printing program 41 activates the auxiliary program 42 corresponding to the printer 2 and passes information indicating that the printer 2 has been selected (A13).

When the auxiliary program 42 is activated in response to the instruction from A13, the auxiliary program 42 acquires the capability information of the printer 2. Specifically, the auxiliary program 42 requests the general-purpose printing program 41 to acquire the capability information (A21). The general-purpose printing program 41 transmits a command requesting the capability information to the printer 2 and acquires the capability information from the printer 2 (A22). The general-purpose printing program 41 passes the acquired capability information to the auxiliary program 42 (A23). Accordingly, the auxiliary program 42 can acquire the capability information of the printer 2.

It is noted that the general-purpose printing program 41 performs communication with the printer 2 via the OS 21 in A22, for example, by communication according to internet printing protocol (IPP). Instead of making a request to the general-purpose printing program 41, the auxiliary program 42 may acquire the capability information directly from the printer 2 using, for example, a management information base (MIB). The capability information that the auxiliary program 42 can acquire from the printer 2 may include more information than the capability information acquired via the OS 21.

The capability information acquired from the printer 2 includes information on setting items that can be set as print settings and parameters that can be set for each setting item. The capability information includes, for example, information on items related to the sheet feeding trays and sheet discharging trays available to the printer 2, such as information indicating the selectable sheet feeding trays and sheet discharging trays, and sheet information such as the sheet size and sheet type of the sheet set in each sheet feeding tray. The capability information may further include information on the print resolution that printer 2 can support, information on the image processing function that printer 2 can execute, information indicating the status of printer 2 such as remaining amount of consumables, information indicating exclusive settings and how to resolve them, and information indicating default print settings. The capability information is used, for example, when the general-purpose printing program 41 or the editing application 43 displays a print setting screen or when determining an exclusive error in the print settings.

The auxiliary program 42 stores the acquired capability information in the memory 12 (A31). The auxiliary program 42 also passes the acquired capability information to the general-purpose printing program 41 (A33). The general-purpose printing program 41 reflects the capability information passed from the auxiliary program 42 on the print setting screen displayed in A03 (A35). For example, when capability information indicating that an additional tray is attached to the printer 2 is received, the general-purpose printing program 41 displays a print setting screen in which the additional tray is shown as an option. Furthermore, the general-purpose printing program 41 may store the capability information passed from the auxiliary program 42 in the memory 12, or may pass the capability information to the editing application 43 to share the capability information with the editing application 43.

The capability information stored in the memory 12 in A31 and the capability information passed to the general-purpose printing program 41 or editing application 43 in A33 may be information that includes all of the capability information acquired from the printer 2, or may be information that includes only part of the capability information acquired from the printer 2. For example, the capability information passed to the general-purpose printing program 41 or the editing application 43 may be only information about print settings that can be accepted by the general-purpose printing program 41 or the editing application 43.

The user performs an operation on the print setting screen that is being displayed to determine the print settings (A37). The capability information of the printer 2 is also passed to the general-purpose printing program 41 and the editing application 43, so that options suitable for the capabilities of the printer 2 are displayed on the print setting screen so as to be selected. The general-purpose printing program 41 can pass the determined print settings to the editing application 43.

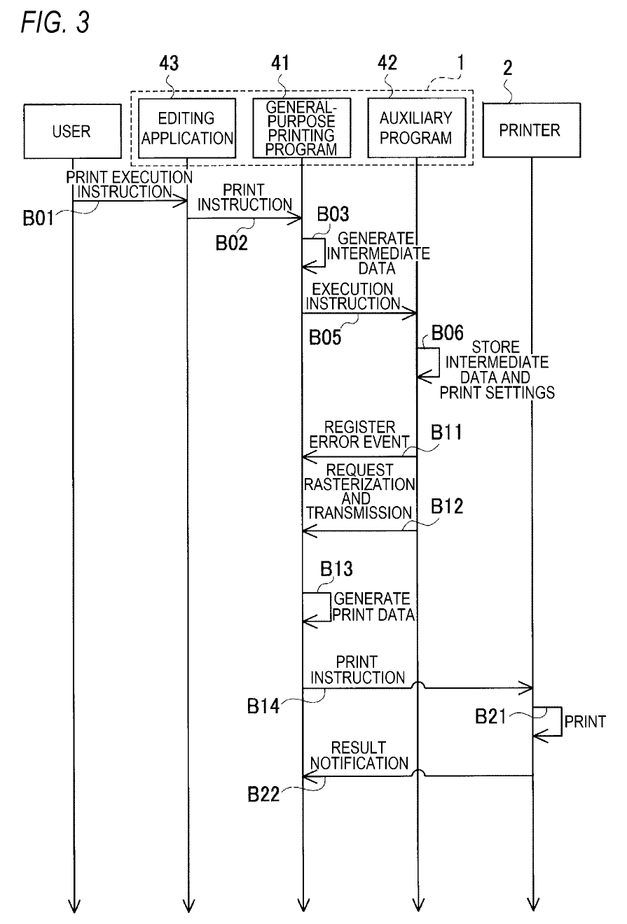

Next, a printing execution procedure will be described with reference to the sequence diagram of FIG. 3. After determining an image to be printed and print settings in the printer 2, a user inputs an instruction for print execution into the editing application 43 (B01). When the editing application 43 receives an instruction for print execution from the user, since the general-purpose printing program 41 is incorporated into the OS 21 of the PC 1, it is determined that an execution instruction to the general-purpose printing program 41 to cause the printer 2 to print the selected image has been received.

The editing application 43 outputs the received print instruction information to the general-purpose printing program 41 (B02). The general-purpose printing program 41 acquires, from the editing application 43, image data indicating an image to be printed and information indicating print settings as information on the print instruction.

The general-purpose printing program 41 generates intermediate data by converting the format of the image data of the image to be printed into the format of the intermediate data based on the information acquired from the editing application 43 (B03). The image data included in the editing application 43 is of various types, and the general-purpose printing program 41 converts the image data to be printed into intermediate data suitable for generating print data. If the image data to be printed is data suitable for generation of the print data, generation of intermediate data may be omitted and the image data may be used as intermediate data as it is.

Before generating the intermediate data, the general-purpose printing program 41 may activate the auxiliary program 42 corresponding to the printer 2, which is the designated device, and notify the auxiliary program 42 that process of the print job has begun. When the auxiliary program 42 is activated from the general-purpose printing program 41, the auxiliary program 42 can pass information indicating various instructions used when generating the intermediate data to the general-purpose printing program 41 as necessary.

After generating the intermediate data, the general-purpose printing program 41 outputs an execution instruction to the auxiliary program 42, thereby activating the auxiliary program 42 (B05). The auxiliary program 42 can acquire the intermediate data generated by the general-purpose printing program 41 by making a request to the general-purpose printing program 41, for example. The auxiliary program 42 can edit the intermediate data or information on print settings received from the general-purpose printing program 41 as necessary. The auxiliary program 42 stores the intermediate data and the information on print settings acquired from the general-purpose printing program 41, or the edited intermediate data and the edited information on print settings, in the memory 12 (B06).

The auxiliary program 42 registers an error event in the general-purpose printing program 41 regarding the current printing (B11). If an error event is registered, the general-purpose printing program 41 activates the auxiliary program 42 and passes information on the error to the auxiliary program 42 in a case where an error notification informing the error is received from the printer 2 that executes printing.

The error event may be registered at any time after the auxiliary program 42 is activated based on the print instruction and before the print data is transmitted to the printer 2. The auxiliary program 42 may register an error event each time a print instruction is issued, or if the general-purpose printing program 41 has a function of maintaining information on error event registration, B11 may be omitted if registration has already been performed. Further, if the general-purpose printing program 41 is configured to output an error event to the auxiliary program 42 when the error notification is received, regardless of whether the error event is registered, B11 is not necessary.

The auxiliary program 42 instructs the general-purpose printing program 41 to rasterize the intermediate data and to transmit raster data, which is data after the rasterization (B12). The general-purpose printing program 41 rasterizes the intermediate data to generate print data (B13), and transmits the generated print data and a print command to the printer 2 (B14). B12 is a process for transmitting a print command to the printer 2, and is an example of the print process.

The auxiliary program 42 may perform the rasterization instead of the general-purpose printing program 41. In this case, the auxiliary program 42 may execute rasterization based on the intermediate data to generate print data, pass the generated print data and the print settings to the general-purpose printing program 41, and instruct the general-purpose printing program 41 to transmit the print data and the print settings to the printer 2. The auxiliary program 42 may process the print data generated by the general-purpose printing program 41 or the auxiliary program 42 as necessary. The print data transmitted to the printer 2 may be in any format that can be printed by the printer 2.

When rasterization is performed by the auxiliary program 42, the degree of freedom is higher as compared with the case where rasterization is performed by the general-purpose printing program 41, and print data suitable for printing by the printer 2 is more likely to be generated. On the other hand, when the rasterization is performed by the general-purpose printing program 41, the number of processes of the auxiliary program 42 is reduced, and the program size of the auxiliary program 42 can be reduced.

Further, instead of transmitting the print data from the general-purpose printing program 41 to the printer 2, the auxiliary program 42 may transmit the print data and a print command instructing execution of printing to the printer 2. For example, if the print settings include a setting related to image processing that can be performed by the printer 2, the auxiliary program 42 may generate a print command including information on the processing.

The printer 2 starts printing based on the received print data (B21). Then, the printer 2 notifies the general-purpose printing program 41 of information indicating the result of the print execution (B22). After the general-purpose printing program 41 transmits the generated print data to the printer 2 in B14, a result notification transmitted from the printer 2 may be received.

When the printing is completed, the printer 2 notifies the general-purpose printing program 41 of the completion of the printing in B22. In this case, the general-purpose printing program 41 notifies the editing application 43 that printing is completed, and ends the process. When the printing is completed, the printer 2 may not notify the general-purpose printing program 41 of the completion of the printing. In this case, the general-purpose printing program 41 operates on the assumption that the printing is completed based on the completion of the transmission of the generated raster data to the printer 2.

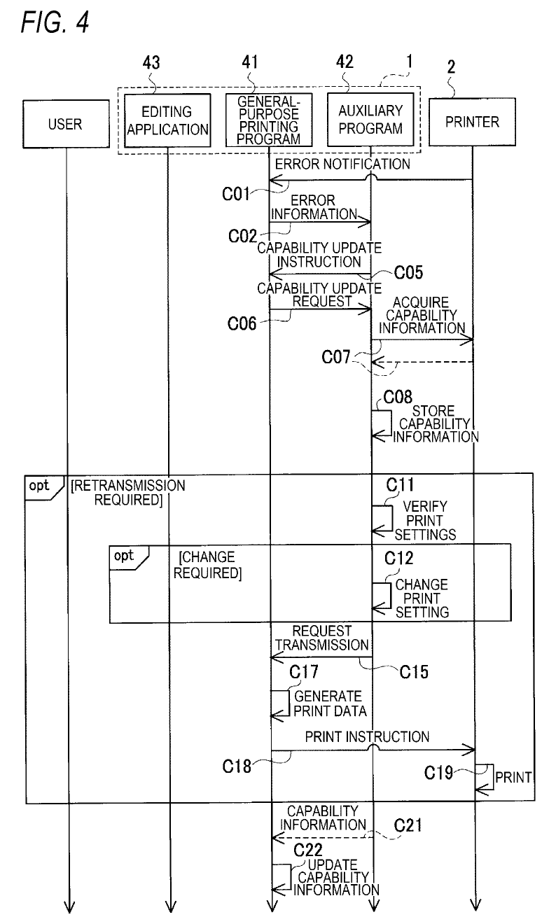

On the other hand, if an error occurs during the print process in the printer 2, the printer 2 transmits an error notification including information about the error that occurred to the general-purpose printing program 41 in B22. A procedure to be performed after an error occurs in the printer 2 will be described with reference to the sequence diagram of FIG. 4.

If an error occurs during printing, the printer 2 transmits an error notification to the general-purpose printing program 41 in B22 of FIG. 3 (C01). When the general-purpose printing program 41 receives an error notification from the printer 2 while an error event is registered in B11 of FIG. 3, the auxiliary program 42 is activated, and error information indicating that an error has occurred in the printer 2 is outputted to the auxiliary program 42 (C02). As a result, the auxiliary program 42 acquires the error information. The error information that the auxiliary program 42 receives from the printer 2 via the general-purpose printing program 41 is information indicating that the capabilities of the printer 2 may have changed, and is an example of specific information. C02 is an example of the acquisition process.

The error notification transmitted from the printer 2 may include information indicating the type of error. The types of error include, for example, cover open, no coloring material, extremely small amount of coloring material, small amount of coloring material, no sheet, small amount of sheet, sheet jam, no empty space in sheet discharging tray, little empty space in sheet discharging tray, sheet size mismatch, or the like.

The general-purpose printing program 41 may simply pass information on the error notification received from the printer 2 to the auxiliary program 42 in C02. Further, in C02, the general-purpose printing program 41 may simply activate the auxiliary program 42 and may not output the error information. In this case, the auxiliary program 42 may request the general-purpose printing program 41 to acquire the error information. The general-purpose printing program 41 or the auxiliary program 42 may also display the error information on the user IF 13.

If an error occurs in the printer 2 during printing, it is possible that the error has occurred due to a change in the capabilities of the printer 2. For example, if the capabilities of the printer 2 have changed from the capabilities indicated in the capability information acquired in A23 of FIG. 2, the print settings may not be compatible with the current capabilities of the printer 2. For example, an error may occur if the sheet discharging tray specified in the print settings is unavailable or if the sheet set in the specified sheet feeding tray is changed.

Further, even if the printing of the received print data is completed, the printer 2 may be able to transmit an error notification when the capabilities of the printer 2 have changed since the last time the capability information was transmitted. For example, the printer 2 may transmit an error notification if the capabilities have changed since the last time the capability information was transmitted. When the capabilities have changed, the printer 2 transmits an error notification, so that the auxiliary program 42 can know that the capabilities of the printer 2 have changed.

In response to receiving the error information, the auxiliary program 42 outputs a capability update instruction to the general-purpose printing program 41 (C05). When the general-purpose printing program 41 receives the capability update instruction, the general-purpose printing program 41 outputs a capability update request to the auxiliary program 42 (C06). The capability update request is an instruction from the general-purpose printing program 41 to the auxiliary program 42 requesting information for updating the capability information held in the general-purpose printing program 41. The auxiliary program 42 can receive a capability update request from the general-purpose printing program 41 by outputting the capability update instruction to the general-purpose printing program 41.

Upon receiving the capability update request, the auxiliary program 42 acquires the current capability information from the printer 2 (C07). The auxiliary program 42 may acquire the capability information by making a direct request to the printer 2, or may acquire the capability information via the general-purpose printing program 41 by making a request to the general-purpose printing program 41, as in A21 to A23 of FIG. 2. Further, the auxiliary program 42 stores the acquired capability information in the memory 12 (C08). C08 is the same process as A31 of FIG. 2, and is a process for updating the information stored in A31.

Further, the auxiliary program 42 determines, based on the error information received in C02, whether it is necessary to retransmit the print data in order to complete the printing. For example, if the type of error indicated by the error information is "sheet jam" or "cover open," the printer 2 can resume printing if the error is resolved by a user operation. Therefore, the auxiliary program 42 determines that it is not necessary to retransmit the print data. On the other hand, if the type of the error is "no coloring material", there is a high possibility that print data is lost when the user replaces the coloring material. Therefore, the auxiliary program 42 determines that it is necessary to retransmit the print data.

If it is determined that it is necessary to retransmit the print data (opt: [retransmission required]), the auxiliary program 42 further determines whether it is necessary to change the print settings stored in B06 of FIG. 3, that is, whether the print setting is valid (C11). C11 is an example of the determination process. For example, if the sheet discharging tray designated in the print settings is unavailable, there is a high possibility that the error can be resolved by changing the sheet discharging tray designated in the print settings.

If it is determined that it is necessary to change the print settings according to the capability information acquired in C07 (opt: [change required]), the auxiliary program 42 changes the print settings to match the capability information (C12). For example, the auxiliary program 42 changes the sheet discharging tray of the output destination to an available sheet discharging tray. The auxiliary program 42 may notify the user that the print settings have been changed. Further, the auxiliary program 42 may display a message on the user IF 13 indicating that it is necessary to change the print settings, and receive a change to the print settings through a user operation.

The auxiliary program 42 passes the intermediate data stored in B06 of FIG. 3 and the print settings changed as necessary to the general-purpose printing program 41, and requests that the intermediate data be rasterized and transmitted to the printer 2 (C15). The general-purpose printing program 41 generates the print data (C17) and transmits the print data to the printer 2 (C18), similar to B13 and B14 of FIG. 3. The printer 2 executes the printing based on the received print data (C19). C15 is an example of the reprint process. The auxiliary program 42 changes the print settings to suit the current capabilities of the printer 2, and transmits a print command according to the changed print settings to the printer 2 to cause the printer 2 to perform reprinting, so that there is a high possibility that printing can be completed.

Further, the auxiliary program 42 passes the capability information to the general-purpose printing program 41 as a response to the capability update request received in C06 (C21). This allows the general-purpose printing program 41 to update the capability information indicating the capabilities of the printer 2, that is, the information received from the auxiliary program 42 in A33 of FIG. 2 and stored in the memory 12 (C22). The auxiliary program 42 may instruct the general-purpose printing program 41 to update the capability information in C21. C21 is a process for updating the capability information stored in the memory 12, and is an example of an update process.

In response to an error occurring in the printer 2 during printing, the auxiliary program 42 outputs a capability update instruction, acquires capability information again, and updates the capability information of the general-purpose printing program 41 to the latest information. Therefore, from the next printing onwards, it is highly likely that the print instruction corresponds to the current capabilities of the printer 2, and inappropriate print settings can be avoided.

As described above in detail, for example, when the printer 2 is selected, the auxiliary program 42 according to the first aspect causes the CPU 11 of the PC 1 to acquire capability information indicating the capabilities of the printer 2 and store the acquired capability information in the memory 12. Then, when the auxiliary program 42 acquires information indicating that the capabilities of the printer 2 may have changed as the error information, the auxiliary program 42 causes the CPU 11 to acquire the capability information from the printer 2 and update the capability information stored in the memory 12. As a result, after the capability information is updated, the general-purpose printing program 41 can use print settings that reflect the updated capability information. In other words, even if the capabilities of the printer 2 change after the printer 2 is selected, there is a high possibility that the changed capabilities of the printer 2 can be accommodated.

Next, a PC that uses the auxiliary program 42 according to a second aspect will be described in detail with reference to the accompanying drawings. The PC according to the second aspect is different from the first aspect in that it has a built-in status monitor capable of monitoring the printer 2, and the auxiliary program 42 according to the second aspect can utilize information stored by the status monitor. The same configurations and procedures as those of the first aspect are denoted by the same reference numerals as those of the first aspect, and descriptions thereof will be omitted.

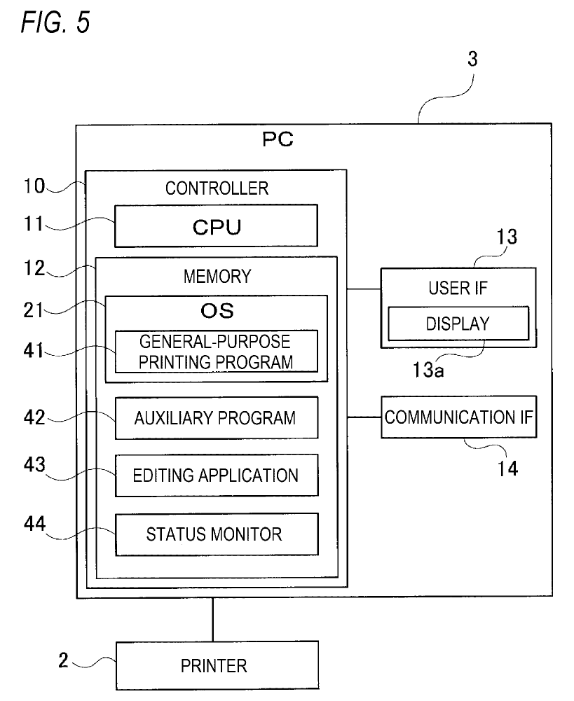

As shown in FIG. 5, the memory 12 of the PC 3 according to the second aspect stores various programs and various data, including the OS 21 including the general-purpose printing program 41, the auxiliary program 42, the editing application 43, and a status monitor 44. The status monitor 44 is a program that enables the CPU 11 to periodically communicate with the printer 2 connected to the PC 3 and periodically acquire status information from the printer 2. The status monitor 44 is an example of the status monitor program.

The status monitor 44 resides in the PC 3 while the PC 3 is being activated, and periodically attempts to communicate with the printer 2. If the printer 2 is online, the status monitor 44 can acquire the status information from the printer 2. The status information includes, for example, information indicating whether the printer 2 is printing or waiting, information indicating a communication state between the PC 3 and the printer 2, information indicating a remaining amount of consumables such as sheets and coloring materials, and information indicating an error if the printer 2 is in an error state.

The status monitor 44 stores the acquired status information in the memory 12 for comparison with the next status information. The status monitor 44 then compares the acquired status information with the previous status information stored in the memory 12, and if there is a change in the capabilities of the printer 2, change information, which is information indicating that there is a change, can be stored in a predetermined memory area of the memory 12. The predetermined memory area of the memory 12 is an area that can be shared by the status monitor 44 and the auxiliary program 42. The predetermined memory area of the memory 12 may be, for example, a Windows registry.

The change information is a flag indicating that there is a change in the capabilities of the printer 2, and may not include information indicating the content of the change. Further, if a change in the status information is a change related to the capabilities of the printer 2, the status monitor 44 may store the change information. In other words, if the change in the status information is, for example, a change in the remaining amount of consumables within a range that does not result in an error or warning, or a change between printing in progress and standby, the status monitor 44 may not store the change information.

For example, if the user changes the sheet size or the sheet type of the sheet set in the sheet feeding tray, the capability of the printer 2 changes. In this case, the status monitor 44 determines that the capability of the printer 2 has changed because the status information has changed to an extent that affects the capability of the printer 2, and stores the change information in the memory 12. The change information stored by the status monitor 44 is an example of the specific information.

The PC 3 according to the second aspect can also execute a print setting procedure and a printing execution procedure as procedures of processes related to printing in the printer 2. The print setting procedure executed by the PC 3 is the same as the print setting procedure in the first aspect shown in the sequence diagram of FIG. 2. In the second aspect, when the capability information is stored in A31 of FIG. 2, if the change information stored by the status monitor 44 is stored in the memory 12, the auxiliary program 42 may delete the change information.

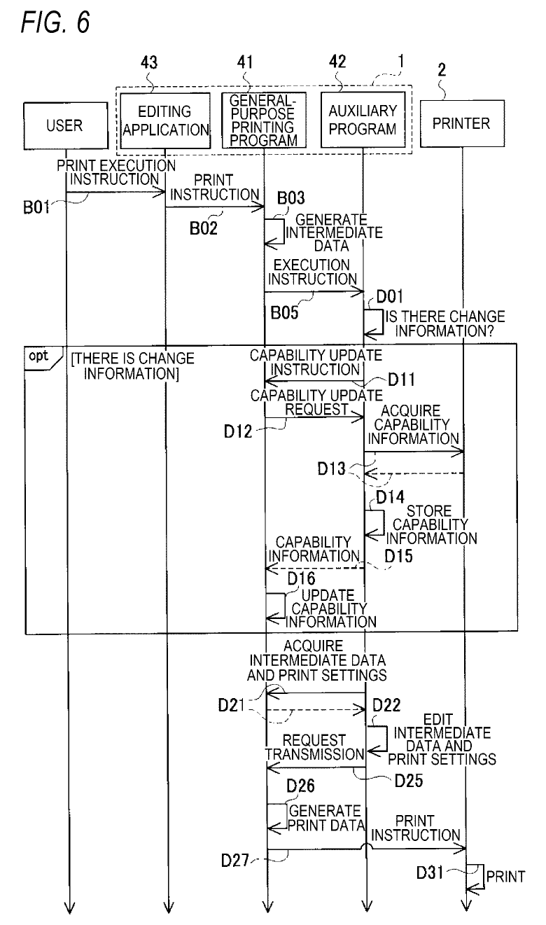

Next, the printing execution procedure executed in the second aspect will be described with reference to the sequence diagram of FIG. 6. In FIG. 6, the same steps as those in the printing execution procedure of the first aspect (see FIG. 3) are denoted by the same reference numerals.

The user inputs an instruction for print execution into the editing application 43 (B01). The editing application 43 outputs the received print instruction information to the general-purpose printing program 41 (B02). The general-purpose printing program 41 generates intermediate data based on the image data of the image to be printed (B03). After generating the intermediate data, the general-purpose printing program 41 outputs an execution instruction to the auxiliary program 42, thereby activating the auxiliary program 42 (B05).

The auxiliary program 42 determines whether the change information is stored in the predetermined memory area of the memory 12 (D01). If it is determined that there is change information (opt: [there is change information]), the auxiliary program 42 outputs a capability update instruction to the general-purpose printing program 41 (D11). When the general-purpose printing program 41 receives the capability update instruction, the general-purpose printing program 41 outputs a capability update request to the auxiliary program 42 (D12).

The auxiliary program 42 acquires the latest capability information from the printer 2 (D13) and stores the acquired capability information in the memory 12 (D14). D11 to D14 are the same procedures as C05 to C08. Furthermore, the auxiliary program 42 passes the capability information to the general-purpose printing program 41 (D15). This allows the general-purpose printing program 41 to update the capability information indicating the capabilities of the printer 2 (D16). D15 is a procedure similar to C21 and is an example of the update process. After updating the capability information to the latest information, the auxiliary program 42 may delete the change information stored by the status monitor 44.

The auxiliary program 42 acquires the intermediate data and print setting information by making a request to the general-purpose printing program 41 based on the execution instruction received in B05 (D21). The auxiliary program 42 edits the intermediate data and print settings, if necessary, based on the capability information acquired in D13 (D22). The auxiliary program 42 may automatically edit the intermediate data and print settings, or may receive editing by the user.

The status monitor 44 of the present aspect monitors the capabilities of the printer 2, and stores the change information in the memory 12 when the capabilities change. If the change information is stored, the auxiliary program 42 updates the capability information to the latest information. This makes it highly likely that subsequent printing will be able to accommodate the current capabilities of the printer 2. For example, if the change information is stored when the auxiliary program 42 is activated based on the instruction for print execution, the auxiliary program 42 acquires the latest capability information and edits the intermediate data and print settings, so that the intermediate data and print settings corresponding to the current capabilities of the printer 2 can be created. The auxiliary program 42 may check the change information not only when it is activated based on an instruction for print execution, but also when it is activated based on an instruction to set detailed print settings, for example.

The auxiliary program 42 passes the edited intermediate data and print settings to the general-purpose printing program 41, and requests that the intermediate data be rasterized and transmitted to the printer 2 (D25). The general-purpose printing program 41 generates the print data (D26) and transmits the generated print data and a print command to the printer 2 (D27). D25 is a process for transmitting a print command to the printer 2, and is an example of the print process. The printer 2 starts printing based on the received print data (D31).

As described above in detail, similarly to the auxiliary program 42 according to the first aspect, the auxiliary program 42 according to the second aspect causes the CPU 11 to acquire the capability information from the printer 2 and update the capability information stored in the memory 12 in response to acquiring the information indicating that the capability of the printer 2 may be changed after the printer 2 is selected as the change information. Therefore, even if the capabilities of the printer 2 change after the printer 2 is selected, there is a high possibility that the changed capabilities of the printer 2 can be accommodated.

Next, a PC that uses the auxiliary program 42 according to a third aspect will be described in detail with reference to the accompanying drawings. The PC of the third aspect has the same configuration as that of the first aspect. The general-purpose printing program 41 of the third aspect has a function of monitoring the state of the printer 2. The auxiliary program 42 according to the third aspect differs from the auxiliary program 42 according to the first and second aspects in that information acquired by the general-purpose printing program 41 can be used. The same configurations and procedures as those of the first aspect are denoted by the same reference numerals as those of the first aspect, and descriptions thereof will be omitted.

The printer 2 according to the third aspect can transmit error information indicating the occurrence of an error to the PC 1 even if an instruction to execute printing is not received, for example, in a case where an error occurs. That is, the printer 2 executes C01 in FIG. 4 even after not having received B14 in FIG. 3. Further, the printer 2 can output the error information to be transmitted to the PC 1 that includes information indicating that the capabilities of the printer 2 have changed. For example, when the sheet size or sheet type of sheets set in the sheet feeding tray is changed, the printer 2 transmits the error information including information indicating that the capabilities have changed to the PC 1. Even in this configuration, the error information transmitted from the printer 2 is an example of the specific information.

The general-purpose printing program 41 of the third aspect resides, for example, in the PC 1 and can acquire information transmitted from the printer 2 not only after a print command has been transmitted. It is noted that the printer 2 may transmit the error information when requested by the general-purpose printing program 41, rather than spontaneously. For example, the general-purpose printing program 41 may have a function of periodically checking the presence or absence of an error in the printer 2. When the OS 21 including the general-purpose printing program 41 receives the error information from the printer 2, the OS 21 may notify the auxiliary program 42 of the received error information.

The auxiliary program 42 according to the present aspect also executes part of the procedure shown in FIG. 4 when the error information notified from the general-purpose printing program 41 is acquired. When the auxiliary program 42 receives the error information from the general-purpose printing program 41 (C02), the auxiliary program 42 outputs the capability update instruction (C05). For example, the auxiliary program 42 may output the capability update instruction when the error information includes information indicating that the capability has changed.

When the auxiliary program 42 outputs the capability update instruction, C06 to C08 and C21 are executed as described above. As a result, the capability information of the printer 2 stored in the memory 12 by the general-purpose printing program 41 is updated. That is, the information indicating the changed capabilities of the printer 2 is shared between the auxiliary program 42, the general-purpose printing program 41 and the editing application 43. Therefore, thereafter, the possibility of receiving print settings that are inappropriate for the capabilities of the printer 2 is reduced.

As described in detail above, the auxiliary program 42 according to the third aspect, similarly to the auxiliary program 42 according to the first aspect, updates the capability information stored in the memory 12 if the capabilities of the printer 2 change after the printer 2 is selected. Therefore, there is a high possibility that the changed capabilities of the printer 2 can be accommodated thereafter.

Each of the aspects disclosed in the present specification are merely an example, and does not limit the present invention. Therefore, various improvements and modifications can be naturally made to the technique disclosed in the present specification without departing from the gist of the present invention. For example, the printer 2 connected to the PC 1 is not limited to a single-function printer, but may be any device that has a printing function, such as a multi function device, a copying machine, or a fax machine. The number of printers 2 connected to the PC 1 is not limited to the illustrated example, and may be two or more.

Further, in A31 of the print setting procedure shown in FIG. 2, the auxiliary program 42 stores the acquired capability information, but the acquired capability information may not be stored. When the acquired capability information is stored and there is no possibility that the capability has changed, the auxiliary program 42 can easily use the capability information by reading out the capability information from the memory 12 for use.

In addition, after the print setting screen is displayed by the general-purpose printing program 41, if the user operates to change a normally used printer from another printer to the printer 2 via the OS 21, the general-purpose printing program 41 may also activate the auxiliary program 42. Furthermore, the auxiliary program 42 may be activated not only when printing is selected, but also when, for example, the printer 2 is selected as a device setting. Even in these cases, the auxiliary program 42 may be able to execute a procedure for updating the capability information.

In each aspect, although only the printing operations have been described in detail as the operations of the auxiliary program 42, the auxiliary program 42 may also have other roles. The program that executes the process of each aspect is not limited to the auxiliary program 42, but may be any program that receives an instruction from the OS 21 or the general-purpose printing program 41 when printing is performed using the general-purpose printing program 41. For example, a print workflow application (Print workflow) whose specifications have been published by Microsoft may be used.

Further, an execution timing of the auxiliary program 42 is not limited to the example in each aspect. For example, it may be executed in response to a direct execution instruction from the OS 21, or may be a resident auxiliary program 42. If it is resident, the auxiliary program 42 may receive an execution command and perform the above-described operations.

In any sequence diagram disclosed in each of the aspects, an execution order of a plurality of processes in any plurality of steps can be freely changed or can be executed in parallel within a range in which no contradiction occurs in a process content.

The processes disclosed in the embodiments may be executed by hardware such as a single CPU, a plurality of CPUs, an ASIC, or a combination thereof. In addition, the processes disclosed in each aspect can be implemented in various modes such as a recording medium in which a program for executing the processes is recorded, or a method.

The support program disclosed in the present specification can cause the computer of the information processing device to acquire specific information indicating that a capability of the printer may be changed, and in response to acquisition of the specific information, acquire capability information from the printer and update the capability information stored in the memory. Therefore, after the specific information is acquired, the computer can be made to use a print setting that reflect the capability information of the printer at that time. Accordingly, there is a high possibility that a change in the capability of the printer can be accommodated.

An information processing device incorporating the support program, a computer-readable storage medium storing the support program, and a control method for implementing a function of the support program are also novel and useful.

The technique disclosed in the present specification implements the technique that can easily accommodate the current capability of a printer in an information processing device in which an OS-standard general-purpose printing program is incorporated.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a support program that is executable by a computer of an information processing device, corresponds to a printer connected to the information processing device, and supports a general-purpose printing program incorporated in an operating system of the information processing device,
wherein at least one of the general-purpose printing program and the support program causes the computer to communicate with the printer to acquire capability information indicating a capability of the printer, and store the acquired capability information in a memory of the information processing device,
wherein the general-purpose printing program and the support program are configured to cause the computer to receive a print setting for causing the printer to execute printing based on the capability information stored in the memory,
wherein the support program causes the computer to execute an acquisition process of acquiring specific information indicating that a capability of the printer is changed, and
wherein the support program further causes the computer to execute, in response to acquisition of the specific information in the acquisition process, an update process of acquiring the capability information from the printer and updating the capability information stored in the memory.

2. The storage medium according to claim 1,
wherein the support program causes the computer to instruct the general-purpose printing program to update the capability information in response to acquisition of the specific information in the acquisition process, and execute the update process according to the instruction.

3. The storage medium according to claim 1,
wherein in the acquisition process, the specific information notified from the general-purpose printing program is acquired, and the general-purpose printing program is configured to receive the specific information from the printer, and when the specific information is received, notify the support program of the received specific information, and
wherein the support program causes the computer to execute the update process in response to acquisition of the specific information from the general-purpose printing program in the acquisition process.

4. The storage medium according to claim 3,
wherein the support program causes the computer to execute a print process of transmitting a print command to the printer when a process is requested from the general-purpose printing program in response to a print instruction to the general-purpose printing program to cause the printer to perform printing, and
wherein the support program further causes the computer to execute the update process in response to acquisition of the specific information in the acquisition process after the print command is transmitted to the printer.

5. The storage medium according to claim 4,
wherein the specific information is error information indicating that an error has occurred in the printer,
wherein in the acquisition process, the error information notified from the general-purpose printing program is acquired, and the general-purpose printing program is configured to receive the error information from the printer, and when the error information is received, notify the support program of the error information, and
wherein the support program causes the computer to execute the update process in response to acquisition of the error information from the general-purpose printing program in the acquisition process after the print command is transmitted to the printer.

6. The storage medium according to claim 5,
wherein the support program causes the computer to execute:
a determination process of determining whether a print setting specified by the print instruction is valid based on the capability information updated by the update process; and
when it is determined that the print setting specified by the print instruction is invalid in the determination process, a reprint process of changing the print setting specified by the print instruction to a valid print setting and transmitting a print command conforming to the changed print setting to the printer.

7. The storage medium according to claim 3,
wherein the specific information is error information indicating that an error has occurred in the printer,
wherein in the acquisition process, the error information notified from the general-purpose printing program is acquired, and the general-purpose printing program is configured to receive the error information from the printer, and when the error information is received, notify the support program of the error information, and
wherein the support program causes the computer to execute the update process in response to acquisition of the error information from the general-purpose printing program in the acquisition process.

8. The storage medium according to claim 7,
wherein the printer is configured to, when a capability of the printer changes, output information indicating that the capability is changed in the error information, and
wherein the support program causes the computer to execute the update process in response to acquisition of the error information, including the information indicating that the capability is changed, from the general-purpose printing program in the acquisition process.

9. The storage medium according to claim 1,
wherein in the acquisition process, the specific information is acquired by being read from a predetermined memory area of the information processing device, a status monitor program is incorporated into the information processing device, the status monitor program periodically communicates with the printer to monitor a capability of the printer, and when there is a change in the capability of the printer, the specific information is stored in the predetermined memory area, and
wherein the support program causes the computer to execute, in a case where the specific information is stored in the predetermined memory area, the update process in response to acquisition of the specific information from the predetermined memory area in the acquisition process.

10. The storage medium according to claim 9,
wherein the support program causes the computer to execute, when a process is requested from the general-purpose printing program in response to a print instruction to the general-purpose printing program to cause the printer to perform printing, the acquisition process and a print process of transmitting a print command to the printer.
